(19) United States
(12) Patent Application Publication
(10) Pub. No.: US 2002/0095736 A1
(43) Pub. Date: Jul. 25, 2002

(54) Layered scraper cup

(76) Inventor: Donald D. Savard, Edmonton (CA)

Correspondence Address: DAVID L. DAVIS, ESQ., 203 MAIN STREET, METUCHEN, NJ, 08840, US

(21) Appl. No.: 10/020,124

(22) Filed: Dec. 7, 2001

(30) Foreign Application Priority Data
Dec. 11, 2000 (CA) 2,327,979

(51) Int. Cl. B08B 9/055

(52) U.S. Cl. 15/104.061

(57) ABSTRACT

A resilient scraper cup made from elastic material and intended for use in propelling a pipeline pig and/or scraping the interior of a pipeline having a predetermined inside diameter. Rather than the usual integrally formed cup used in pipeline servicing vessels, the invention proposes two segments, an inner and an outer segment. The two segments overlap each other but are freely separable from each other. Accordingly, when the outermost friction surface of the cup is worn out, the only part that requires replacement is the outer segment. Since the outer segment has thickness of only about 50% of than the inner segment, or carrier, the cost of such replacement is substantially smaller than replacement or refurbishing of the existing integrally formed cup.

The present intention relates to scraper cups made from resilient polymeric material and used in pipeline servicing pigs for scraping the inner wall of a pipeline, for propelling a pig through the pipeline over substantial lengths of several kilometres, or the like.

### BACKGROUND OF THE INVENTION

It is known that pipeline pigs or vessels require resiliently sealing guide members at least at the leading and trailing end of the vessel and often even between the two. Many different types of such members or cups are known. A typical cup has a usually planar front face wall and a suitably configured outer perimeter portion which sealingly slides over the interior wall of a pipeline.

Examples of known cups of this type are shown, for instance, in U.S. Pat. No. 5,295,279 (Cooper) or U.S. Pat. No. 6,067,682 (Rankin). In these embodiments, the leading face of the cup is typically provided with means for securement of the cup to the vessel, usually a series of circularly arranged set of openings adapted to receive bolts by which the cup is secured to at least a leading and a trailing part, usually a flange, of an associated vessel.

Another example of cups of this type, used in a multiple arrangement on a single vessel, is disclosed in U.S. Pat. No. 3,025,118. The manufacture of a composite cup wherein the outer, friction part of the cup is different from the carrier body of the cup is shown in U.S. Pat. No. 5,271,118.

The common disadvantage of the embodiments disclosed by the above prior art is that when the cup becomes worn, the entire set of cups is replaced or refurbished. This is not only wasteful from the standpoint of the cost, which is usually in the range of about $1000.00 per cup, but it also requires labour intensive mechanical work in the refurbishing which is usually done in special molds in which a suitable polymeric substance is poured for becoming integral with the rest of the worn cup. Attempts have been made (e.g. U.S. Pat. No. 5,035,021—Le Devehat) to avoid the need for replacement of the entire cup by providing a set of friction rings made from elastic material and mounted in a carrier body likewise made from an elastic material. While such arrangement presents certain improvement, it still suffers from the drawback of a complex, labour intensive replacement operation required every time a replacement is to be made. A somewhat similar, albeit outdated and presently prohibited structure of the pig is shown in an old U.S. Pat. No. 2,402,796 (Wood) where a steel carrier is provided with a rubber lip at its periphery. The carrier presents a complex structure which not only is not resilient in itself and thus no longer permitted for use in servicing pipelines, but also requires a high degree of mechanical skill to replace the sealing lips which are fixedly secured to the carriers.

### SUMMARY OF THE INVENTION

It is an object of the present invention to provide a further advance in the art of scraper cups of the type presently required in pipeline maintenance work, i.e. cups which are made from resilient polymeric material throughout to avoid damage to the pipeline serviced.

In general terms, the invention provides a resilient scraper cup made from elastic material and intended for use in propelling a pipeline pig and/or scraping the interior of a pipeline having a predetermined inside diameter, said scraper cup having a carrier segment and a friction ring segment. The carrier segment comprises a radially disposed, integrally formed resilient body having a leading face portion and a trailing face portion. Securement means, e.g. bolt receiving openings, are provided for enabling the securement of the radial body to a pipeline pig or vessel. The carrier segment further includes a radially outer circumferential portion which is integrally formed with the body. It has a diameter smaller than the inside diameter of the pipeline. The friction ring segment includes an inside circumferential section complementary with the radially outer circumferential portion of the body. The ring segment further includes a radially outer circumferential section having a diameter larger than the inside diameter of the pipeline when the cup is in a relaxed state. In order to prevent axial displacement of the ring from the carrier during the passage of the vessel through the pipeline, a radially disposed face section complementary with and overlapping the leading face portion is provided. It assures firm but readily separable engagement therewith as the associated pig travels through the pipeline. In accordance with the invention, the segments are two complementary but separate, distinct parts of the scraper cup freely removable from each other when the pig is outside the pipeline and the securement bolts removed. By the same token, the overall structure of the cup is such that the carrier is strong enough to keep the outer ring in place even when a high friction and high load is encountered by the ring during the passage through the pipeline.

Thus, the replacement of a worn part does not require an expensive spare part (the separable ring costs only about 40% of the cost of full cup). Also, it does not require a complex and expensive refurbishing of the worn periphery, as it is practised in prior art. As mentioned, like the carrier, the replacement ring of the present invention friction ring segment is also made from elastic polymeric material. It includes an inside circumferential section complementary with the radially outer circumferential portion of the carrier. It has an outer circumferential section whose diameter is larger than the inside diameter of a pipeline in which the cup is to operate. In order to keep the ring firmly on an associated carrier, a radially inwardly directed annular face section is integrally formed with a leading end of the circumferential section of the ring. The annular face section is complementary with the leading face portion of an associated carrier segment for firm but readily separable engagement therewith.

### BRIEF DESCRIPTION OF THE DRAWINGS

The invention will be described in greater detail with reference to the accompanying drawings. In the drawings:

FIG. 1 is a diagrammatic, not-to-scale perspective view showing the cup of the present invention attached to a vessel, ready to be inserted into a pipeline.

FIG. 2 is a simplified, diagrammatic, not-to-scale cross section showing the cup in a state of having been inserted in a pipeline, the parts of the pipeline pig to which the cup is secured not being shown;

FIG. 3 is an end view of FIG. 2; and

FIG. 4 is a view similar to that of FIG. 2 but showing the shape of the preferred embodiment of the cup in a relaxed state and in more detail and including exemplary measurements of a particular size of the layered cup of the present invention.

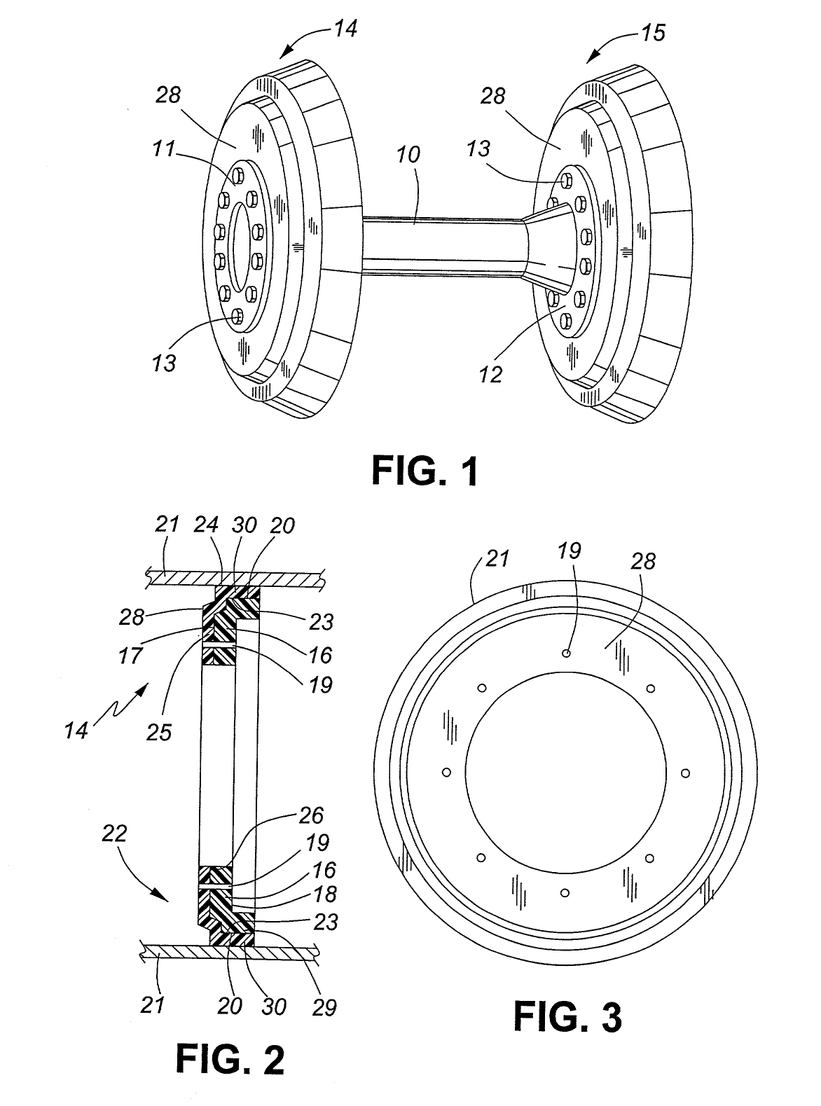

Reference numeral 10 designates a body of a pipeline pig. The actual shape and configuration of the body of the pig does not form any part of the invention and may therefore differ from what is shown in FIG. 1 without departing from the invention. Flanges 11, 12 are secured to the body 10 at the front or upstream end thereof (flange 11) and at the downstream or rear end of the body 10. Bolts 13 extend through the flanges 11, 12 to hold the cups 14, 15 in place.

The structure of the cups is identical for both ends but this, again, is an optional feature. For simplicity, only the cup 14 is shown in FIG. 2. It comprises a radially disposed, resilient body 16. The body 16 has a leading face portion 17 and a trailing face portion 18. There are passages or openings 19 provided about of the body 16 through which the bolts 13 pass when the cup 14 is secured to the body 10. The openings 19 present a preferred, but not the only, embodiment of what is generally referred to as “securement means for enabling the securement of the radial body 16 to a pipeline pig.” The body 16 further includes a radially outer circumferential portion 20 having, in the embodiment shown, the shape of a rearwards extending lip 29. As can be seen from FIG. 2, the lip 29 is integrally formed with the body 16 and has an outside diameter of the portion 20 smaller than the inside diameter of the pipeline 21.

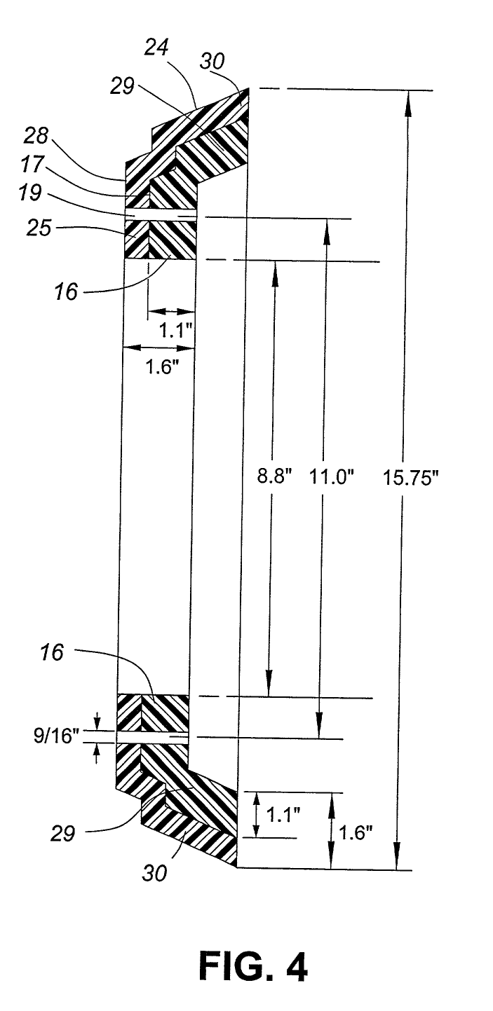

The body 16 is also referred to as a “carrier segment” of the cup″ as it has strength sufficient to carry a friction ring segment 22 and to keep it in sealing contact with the interior of the pipeline 21. The segment 22 is similar in shape to the carrier 16 but is only about F1/2 of thickness of same. It is not integrally formed with the carrier 16. Instead, it is discrete, separate and readily removable from the carrier 16. The ring segment has an inside circumferential section 23 which is complementary in shape with the radially outer circumferential portion 20 of the lip 29 of the body 16. The radially outer circumferential section 24 is shown, in FIG. 2, as being of the same diameter as the inside diameter of the pipeline 21, it being understood that this is only the situation where the cup is in operation inside the pipeline 21. Otherwise, in a relaxed state, it is conical (see FIG. 4) and has the outer diameter larger than the inner diameter of the pipeline 21. The friction segment 22, like the carrier segment 16, has, at its leading end, a body 25 which is of the same contour as that of the body 16 of the carrier but is substantially thinner. The trailing face portion 26 of the body 25 overlaps the leading face portion 17 of the carrier. It is provided with holes complementary with the bolt holes 19 of the carrier 16.

It can be observed that, at least in the relaxed state, the circumferential portion 20 of the body 16 and the inside circumferential section 23 of the friction ring segment 22 are conical and converge in the axially forward direction towards the leading face portion 17, 28, respectively.

As mentioned above, the peripheral portion of the carrier 16 is defined by the annular lip 29 The peripheral portion of the friction ring segment 22 is also defined by an annular lip 30. Both lips 29, 30 extend rearwards from the respective face section 17, 28.

Turning now briefly to the representation of FIG. 4, the measurements shown in this exemplary cup for use in pipelines having a nominal 16 inch outside diameter indicate that the overall thickness of the friction segment of the cup is about one-third of that of the body. Reference may be had, for instance to the thickness of the lip 29 of the carrier 16 which is 1.1″, while the corresponding thickness of the friction segment lip 30 overlapping the lip 29 is only 0.5″ providing the total thickness 1.6″ shown in the drawing. The same ratio would apply to correspondingly modified sizes which may typically cover the range of 6″ or greater.

The invention substantially reduces the cost of maintaining the pipeline pig cups. As mentioned above, the integrally formed, worn cups are either replaced with a new cup or refurbished by applying a renewed outer peripheral portion. The cost of refurbishment used in prior art is about ⅔ of the cost of a new cup. The cost of producing the thinner outer layer of the cup in accordance with the present invention is lower than either one of the known methods.

Those skilled in the art will readily appreciate that many embodiments of a layered cup may be produced differing from the embodiments disclosed, without departing from the scope of the invention as set forth in the accompanying claims.

1. A resilient scraper cup made from elastic material and intended for use in propelling a pipeline pig and/or scraping the interior of a pipeline having a predetermined inside diameter, said scraper cup having a carrier segment and a friction ring segment, said carrier segment comprising:
(a) a radially disposed, integrally formed resilient body having a leading face portion and a trailing face portion and including:
i) securement means for enabling the securement of the radial body to a pipeline pig;
ii) a radially outer circumferential portion integrally formed with the body and having a diameter smaller than said inside diameter;
(b) said friction ring segment including:
i) an inside circumferential section complementary with said radially outer circumferential portion of the body;
ii) a radially outer circumferential section having a diameter larger than said inside diameter, when the cup is in a relaxed state;
iii) a radially disposed face section complementary with said leading face portion for firm but readily separable engagement therewith;
(c) said segments being two complementary but separate, distinct parts of the scraper cup removable from each other when the pig is outside the pipeline.

2. The cup of claim 1 wherein the circumferential portion of the body and of the inside circumferential section of the friction ring are conical and converge in the axially forward direction towards the leading face portion.

3. The cup of claim 2, wherein the radially outer circumferential section includes an annular lip extending from said face section in a direction axially away from said trailing face portion.

4. The cup of claim 3, wherein the radially outer circumferential portion of the carrier segment includes an annular lip extending axially rearwards, away from said trailing face portion.

5. For use with a carrier segment of a resilient scraper cup made from elastic material and intended for use in a pipeline servicing pig, said carrier segment being made from a resilient polymeric material and having a radially disposed, integrally formed body having a leading face portion and a trailing face portion and including a radially outer circumferential portion integrally formed with the body and having a predetermined outer diameter:
a friction ring segment made from elastic material and including:
(a) an inside circumferential section complementary with the radially outer circumferential portion of the body;
(b) an outer circumferential section having a diameter larger than the inside diameter of a pipeline in which a pig provided with the scraper cup is to be used;
(c) a radially inwardly directed annular face section integrally formed with a leading end of said circumferential section and adapted to engage the leading face portion of an associated carrier segment for firm but readily separable engagement therewith.

6. The friction ring segment of claim 5, wherein said outer circumferential section is conical and converges in an axially forward direction away from said annular face section.

7. The friction ring segment of claim 6, wherein outer circumferential section is an annular lip extending axially rearwards in a direction away from the annular face section at an outermost section of the annular face.
